(19) United States
(12) Patent Application Publication
(10) Pub. No.: US 2012/0326549 A1
(43) Pub. Date: Dec. 27, 2012

(54) FIXING A PERMANENT MAGNET IN A DRIVING MOTOR ROTOR

(75) Inventors: Jaewon Ha, Yongin (KR); Jaeyoung Kie, Seongnam (KR); Jungwoo Lee, Hwaseong (KR)

(73) Assignees: KIA MOTORS CORPORATION, Seoul (KR); HYUNDAI MOTOR COMPANY, Seoul (KR)

(21) Appl. No.: 13/313,353

(22) Filed: Dec. 7, 2011

(30) Foreign Application Priority Data
Jun. 23, 2011 (KR) 10-2011-0061229

(51) Int. Cl. H02K 1/28; H02K 15/03

(52) U.S. Cl. 310/156.21; 29/598

(57) ABSTRACT

A method of fixing a permanent magnet in a rotor of a driving motor, e.g., for a vehicle, includes inserting the permanent magnet into a core of the rotor and fixing the permanent magnet by supplying resin to the permanent magnet, wherein a coefficient of thermal expansion of the resin is substantially equal to that of the rotor core.

### CROSS-REFERENCE TO RELATED APPLICATION

This application claims priority to and the benefit of Korean Patent Application No. 10-2011-0061 229 filed in the Korean Intellectual Property Office on Jun. 23, 2011, the entire contents of which are incorporated herein by reference.

### BACKGROUND OF THE INVENTION

(a) Field of the Invention

The present invention relates to a rotor of a driving motor, e.g., for a vehicle, and the fixing of a permanent magnet in a rotor of the vehicle driving motor. More particularly, the present invention relates to fixing the permanent magnet in the rotor by supplying resin to the permanent magnet having a coefficient of thermal expansion substantially equal to that of a rotor core.

(b) Description of the Related Art

Conventionally, a permanent magnet is fixed within a rotor of a driving motor for a vehicle, for example a hybrid vehicle, an electric vehicle, and so on, through application of a resin molding. For instance, in one conventional technique for using resin, when supplying resin, a permanent magnet is uniformly contacted to a rotor core, or else a supplied resin is uniformly applied.

FIG. 1 is a partial cross-sectional view of a conventional interior permanent magnet motor. Referring to FIG. 1, for example, a stator core 18 includes teeth 16 formed radially, slots (apertures) 14 formed between the teeth 16, and a yoke 12 integrally formed with the teeth 16 and shaped as a ring, and a coil 30 is coiled around the teeth 16.

A rotor 20 including a rotor core 21 is disposed within the stator core 18, and a plurality of permanent magnets 25 are inserted into the rotor core 21 along a circumferential direction.

When the permanent magnets 25 are inserted into the rotor core 21, as shown, two separate structures of the permanent magnet 25, each regarding one magnetic pole, may be applied, where the two separated permanent magnets 25 are symmetrically disposed.

In the conventional art, cracks of the molding resin used for fixing the permanent magnets may be possible due to differences between thermal expansion of the rotor core and the resin when temperature rises, and thus fixing durability of the motor may be deteriorated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a rotor of a driving motor for vehicle and a method of fixing a permanent magnet in a rotor of a driving motor for a vehicle which may enhance fixing durability of a permanent magnet in a rotor and a motor.

A method of fixing a permanent magnet in a rotor of a driving motor for a vehicle according to an exemplary embodiment of the present invention may include inserting the permanent magnet into a core of the rotor and fixing the permanent magnet by supplying resin to the permanent magnet, wherein a coefficient of thermal expansion of the resin is substantially equal to that of the rotor core.

A rotor of a vehicle driving motor according to an example of the present invention may include a permanent magnet and a rotor core, wherein the permanent magnet is inserted into the rotor core, and the permanent magnet is fixed by supplying resin to the permanent magnet, and coefficients of thermal expansion of the resin and the rotor core are substantially equal.

According to the exemplary embodiments of the present invention, cracks due to thermal expansion may be prevented. Also, in the exemplary embodiment of the present invention, fixing durability of a permanent magnet in a rotor and a motor may be enhanced. Further, in the exemplary embodiment of the present invention, electric noise due to movement or breakaway of the permanent magnet induced by resin cracking may be reduced.

### BRIEF DESCRIPTION OF THE DRAWINGS

FIG. 1 is a cross-sectional view of a conventional interior permanent magnet motor.

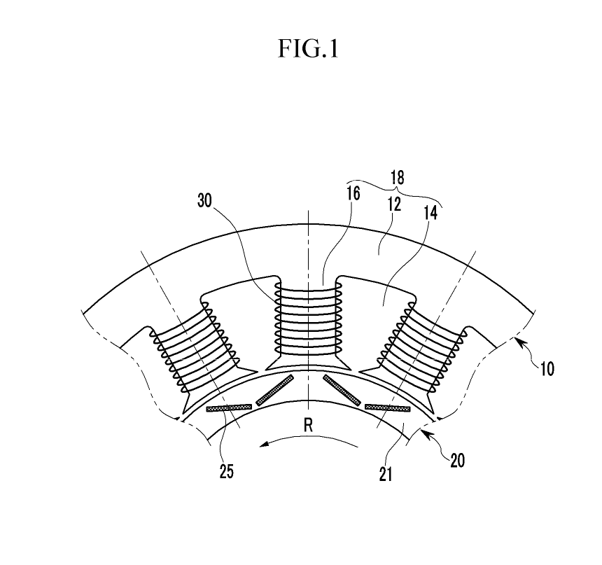

FIG. 2 is a cross-sectional view of a rotor according to an exemplary embodiment of the present invention.

### DESCRIPTION OF SYMBOLS

10: stator

12: yoke

14: slot

16: tooth

18: stator core

20: rotor

21: rotor core

25: permanent magnet

100: rotor

120: permanent magnet

140: rotor core

160: resin

### DETAILED DESCRIPTION OF THE EMBODIMENTS

Exemplary embodiments of the present invention will hereinafter be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

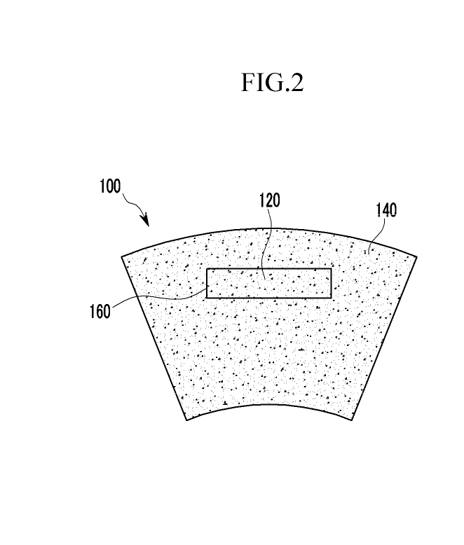

FIG. 2 is a partial cross-sectional view of a rotor according to an exemplary embodiment of the present invention.

Referring to FIG. 2, resin 160 is supplied for fixing a permanent magnet 120 to a core 140 of a rotor 100 and then the resin 160 fixes the permanent magnet 120 at room temperature. According to the present invention, coefficients of thermal expansion of the resin 160 and the rotor core 140 are substantially equal.

When a driving motor (not shown) is operated, temperature of the driving motor rises, and then the rotor core 140 is expanded. Accordingly, the size of a hole (aperture) in which the resin 160 is inserted into is also increased. Simultaneously, the expansion rate of the rotor core 140 is substantially equal to that of the resin 160, and thus cracks in the resin 160 may be prevented, and the permanent magnet 120 remains secured.

In addition, when the driving motor stops and temperature of the driving motor is decreased, the size of the hole into which the resin 160 is inserted into contracts due to contracting of the rotor core 140. According to the invention, however, the resin 160 also contracts at the same rate of the rotor core 140, thus cracks may still be prevented in the resin 160 and the permanent magnet 120 remains secured.

For example, if a thermal expansion coefficient of the rotor core 140 is 1.0×10⁻⁵/° C. at room temperature, and thermal expansion coefficient of the resin 160 is 0.8×10⁻⁵/° C., expansion rate of the resin 160 is just 80% of the expansion rate of the rotor core 140. Thus, if temperature of the drive motor is increase from 20° C. to 150° C. and length of the hole is 40 mm, differences between length of the hole and those of the resin will be more than 0.01 mm.

However, if the thermal expansion coefficient of the resin 160 is substantially equal to that of the rotor core 140 as 1.0×10⁻⁵/° C., that is, if the expansion rates of both are substantially the same, cracks may not be generated, and fixing force for the permanent magnet 120 may be maintained.

Hereinafter, a method of fixing a permanent magnet in a rotor of a driving motor, e.g., for a vehicle, according to an exemplary embodiment of the present invention will be described.

A hole is formed (as an aperture) into the rotor core 140 of the driving motor (not shown) and the permanent magnet 120 is inserted thereinto.

After inserting the permanent magnet 120, the resin 160 is supplied and the permanent magnet 120 is fixed by molding the resin 160.

For preventing cracks of the resin 160 from being generated due to differences in contraction/expansion between the resin 160 and the rotor core 140, the resin 160 used has a coefficient of thermal expansion that is substantially equal to that of the rotor core 140. However, it is not required that both of the thermal expansion coefficients are the same, but differences may be allowed to prevent from generating cracks in the resin 160.

Despite a tendency of breakaway of the permanent magnet 120 due to increasing rotation speed and rises in temperature, the rotor core 140 may securely fix the permanent magnet 120 and thus durability of the rotor core 140 may be improved. Also, durability of the driving motor may be enhanced by securely fixing the permanent magnet 120.

The method of fixing the permanent magnet 120 and the rotor 100 according the exemplary embodiment of the present invention may be applied to any driving motor, particularly for an electric vehicle and a hybrid vehicle and so on.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A method, comprising:
inserting a permanent magnet into a core of a rotor of a driving motor; and
supplying resin to the permanent magnet to fix the permanent magnet within the rotor;
wherein a coefficient of thermal expansion of the resin is substantially equal to that of the core.

2. The method of claim 1, wherein the driving motor is for a vehicle.

3. A rotor of a driving motor; comprising:
a rotor core having a coefficient of thermal expansion;
a permanent magnet inserted into the rotor core; and
a resin supplied to the permanent magnet to fix the permanent magnet to the rotor core, wherein a coefficient of thermal expansion of the resin and the coefficient of thermal expansion of the rotor core are substantially equal.

4. The rotor of claim 3, wherein the driving motor is for a vehicle.

5. A vehicle; comprising:
a driving motor;
a rotor of the driving motor;
a rotor core of the rotor having a coefficient of thermal expansion;
a permanent magnet inserted into the rotor core; and
a resin supplied to the permanent magnet to fix the permanent magnet to the rotor core, wherein a coefficient of thermal expansion of the resin and the coefficient of thermal expansion of the rotor core are substantially equal.

6. The vehicle of claim 5, wherein the vehicle is selected from a group consisting of: an electric vehicle; and a hybrid vehicle.
